(19) United States
(12) Patent Application Publication
(10) Pub. No.: US 2009/0319946 A1
(43) Pub. Date: Dec. 24, 2009

(54) SYSTEM AND METHOD FOR SELECTIVE AND DYNAMIC ELABORATION OF SECURE FORM CONTENT

(75) Inventors: John M. Boyer, Victoria (CA); Vladimir Trakhtenberg, Victoria (CA)

Correspondence Address: IBM CORP. (LOT);C/O Ostrow Kaufman & Frankl LLP, The Chrysler Building, 405 Lexington Avenue, 62nd Floor, NEW YORK, NY, 10174, US

(73) Assignee: INTERNATIONAL BUSINESS MACHINES CORPORATION, Armonk, NY (US)

(21) Appl. No.: 12/143,211

(22) Filed: Jun. 20, 2008

(51) Int. Cl. G06F 3/048

(52) U.S. Cl. 715/810

(57) ABSTRACT

The present invention is directed towards systems and methods for providing interactive document content to a user. The method according to one embodiment of the present invention comprises authoring an interactive document, said interactive document comprising at least one interactive page. A plurality of pages defined within the interactive document are then parsed and stored and an initial plurality of interactive pages may be provided to the user, the initial interactive pages defined within the interactive document. The method may then attach a plurality of pages in response to requests for attachment and is operative to display various pluralities of pages to a user during interaction with the document.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

Embodiments of the invention described herein generally relate to providing interactive document (e.g., electronic form) content to users. More specifically, embodiments of the present invention are directed towards systems and methods for providing interactive document content allowing the attachment and detachment of information while maintaining document integrity and security.

Currently, many applications require large and complex multi-page electronic forms to guide a user through the maze of a branching form filling experience. It is often necessary to deliver these applications via a document-centric architecture (i.e. as a single document). One important reason for the single document architecture is to facilitate the application of a digital signature to the totality of the transaction. A document-centric architecture is also used to service users who are expected to be disconnected from the internet during the fill experience as well as users who must perform an ad hoc workflow via email or similar means to collaboratively create the data content for the application. Finally, a document-centric architecture is also frequently preferred by application developers alike for ease of development, deployment, maintenance, versioning and end-user experience.

The challenge has become one of delivering the required or desired document-centric architecture in a performant manner in the face of dramatically increasing application sizes. Forms requiring tens or even hundreds of individual screens are becoming more and more common. Loading and initializing of such a form becomes a very involved and time consuming operation, degrading overall user experience and often even making form application practically unusable.

The current methodology for solving the problem of delivering a large, complex web application is to break the application into individual screen components (e.g. DHTML pages) delivered one at a time as the user progresses through the application flow. There are several drawbacks to this approach. First, the user must be connected during the form fill experience, which may be difficult or impossible to achieve. Secondly, collaborating users are unable to implement their own ad hoc workflows; instead, workflow must be built into the web application, which may be difficult or impossible to achieve when the form is expected to cross organizational or enterprise access boundaries. Thirdly, when the total transaction represented by the application consists of multiple pages of presentational content, the current methodology offers no consolidation of the content and presentation. This makes it difficult or impossible to perform key operations over the content representing the total transaction, including digital signature security for the transaction as well as interaction with back-end content management and workflow process servers. Thus there exists a need in the art for a system and method for providing performant, larger-scale applications that also provides the benefits of a document-centric architecture.

### BRIEF SUMMARY OF THE INVENTION

The present invention is directed towards systems and methods for providing interactive document content to a user. The method of the present invention includes authoring an interactive document, said interactive document comprising at least one interactive page. In one embodiment, an interactive document may include an XML formatted document wherein the XML document contains data, user interface declarations and behavioral instructions.

The method then stores and parses the interactive document. In one embodiment, parsing the interactive document includes parsing a subset of the original document wherein the subset of the original document comprises pages designated as required pages. The method then provides a plurality of initial interactive page to a user, the initial interactive pages may be defined within the interactive document.

In an alternative embodiment, the method may digitally sign a plurality of pages in response to a request for a digital signature wherein digitally signing a plurality of pages includes deferring signature validations associated with ancillary aspects of the interactive document. The method then attaches a plurality of pages in response to a request for attachment of pages, detaches a plurality of pages in response to a request for detachment of pages and displays a plurality of pages to a user. In a first embodiment, attaching and detaching a plurality of pages may include automatically determining pages to attach and detach. In a second embodiment, attaching and detaching a plurality of pages may include attaching and detaching pages in response to a user request.

The system of the present invention includes a plurality of client devices coupled to a network, the client devices operative to display a plurality of interactive documents comprising a plurality of pages. In one embodiment, an interactive document may include an XML formatted document wherein the XML document contains data, user interface declarations and behavioral instructions.

The system further includes an authoring device operative to enable authoring of an interactive document, the interactive document comprising at least one interactive page and a parser operative to parse the interactive document. In one embodiment, parsing the interactive document includes parsing a subset of the original document wherein the subset of the original document comprises pages designated as required pages.

The system also includes document storage operative to store the interactive document and a rendering device operative to render an interactive document in response to a rendering request. Finally, the system includes a content server operative to provide an initial interactive page to a user, the initial interactive page may be defined within the interactive document and further operative to receive requests from the plurality of client devices, requests comprising requests for the attachment and detachment of pages. In an alternative embodiment, the content server is further operative to digitally sign a plurality of pages in response to a request for a digital signature wherein digitally signing a plurality of pages includes deferring signature validations associated with ancillary aspects of the interactive document. In one embodiment, attaching and detaching a plurality of pages comprises automatically determining pages to attach and detach. In an alternative embodiment, attaching and detaching a plurality of pages comprises attaching and detaching pages in response to a user request.

### BRIEF DESCRIPTION OF THE SEVERAL VIEWS OF THE DRAWINGS

The invention is illustrated in the figures of the accompanying drawings which are meant to be exemplary and not limiting, in which like references are intended to refer to like or corresponding parts, and in which:

FIG. 1 presents block diagram depicting a system for providing interactive document content to a user according to one embodiment of the present invention;

FIG. 2 presents a flow diagram illustrating a method for authoring and presenting an interactive document to a user according to one embodiment of the present invention;

FIG. 3 presents a flow diagram illustrating a method for attaching and detaching interactive document content according to one embodiment of the present invention; and

FIG. 4 presents a flow diagram illustrating a method for attaching a page to an interactive document according to one embodiment of the present invention.

### DETAILED DESCRIPTION OF THE INVENTION

In the following description, reference is made to the accompanying drawings that form a part hereof, and in which is shown by way of illustration specific embodiments in which the invention may be practiced. It is to be understood that other embodiments may be utilized and design changes may be made without departing from the scope of the present invention.

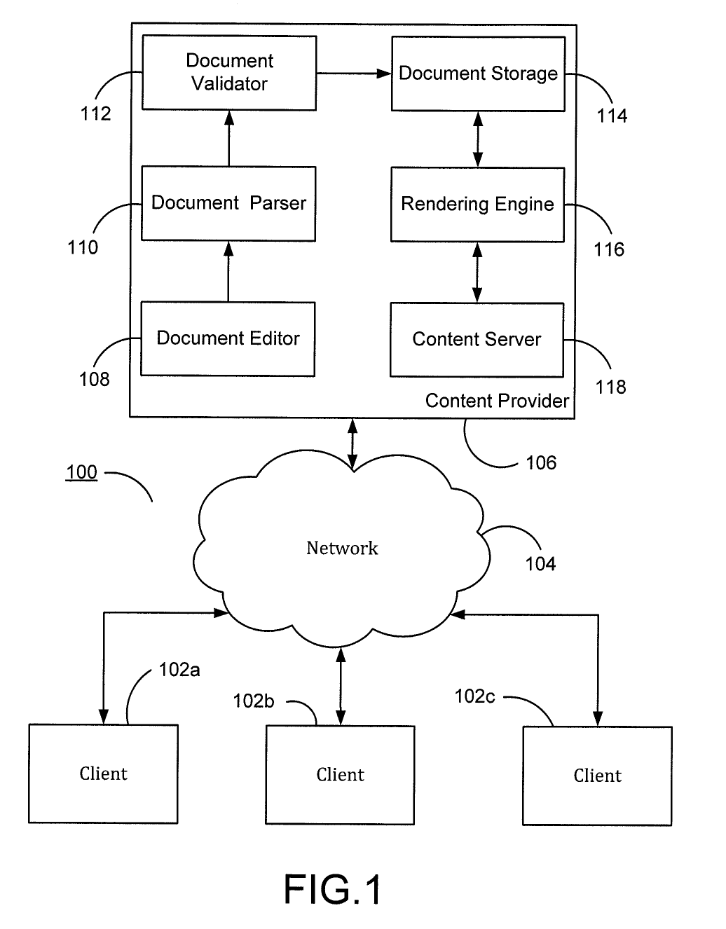

FIG. 1 presents block diagram depicting a system for providing interactive document content to a user according to one embodiment of the present invention. As illustrated, the system 100 includes a plurality of client devices 102 coupled to a network 104. Network 104 is further coupled to a content provider 106 including a document editor 108, document parser 110, document validator 112, document storage module 114, rendering engine 116 and content server 118.

In the illustrated embodiment, client devices 102 may include general purpose user computers having a central processing unit, memory unit, permanent storage, optical drive(s), universal serial bus port(s), audio/video output devices, etc. Furthermore, a client device 102 may include a web browser operative to send network requests, receive network responses and present or display data to the user. Alternatively, or in conjunction with the foregoing, a client device 102 may comprise additional applications operative to display information to an operating user.

Client devices 102 are communicatively coupled to a network 104 operative to transmit data between client devices 102 and content provider 106. In the illustrated embodiment, network 104 may include a connection to one or more local or wide area networks, such as the Internet.

Content provider 106 is communicatively coupled to network 104 and is operative to transmit data to client devices 102 as well as receive requests for data from client devices 102. Content provider 106 includes the document editor 108 operative to generate interactive documents. In one embodiment, the document editor 108 may be an interactive or WYSIWYG editor allowing a user to author interactive documents. Interactive documents may contain a plurality of elements including form elements, formatting elements, display elements, functional code or any elements deemed appropriate for creating a document having interactivity. For example, an interactive document may comprise an XML formatted document containing a plurality of XML tags and content within the XML tags such as XML data or XForms processing markup.

Document parser 110 may include a processing device operative to read and manipulate a formatted, interactive document. In one embodiment, document parser 110 reads an interactive document into memory (not shown) and converts the interactive document to a processing object, such as an XML DOM object or similar construct able to store and update the content, structure or style of documents.

Document validator 112 may include a processing device operative to validate a document object received from document parser 110. In one embodiment, validating a document object may include inspecting the object to ensure the object conforms to predefined constraints. Additionally, document validator 112 may be operative to perform core cryptographic signature validations associated with the document object. In one embodiment, signature validations directed towards ancillary aspects of the document object (e.g., layout aspects) may be deferred for a later time, such as when the subsection of the document object is displayed on a user device. In an alternative embodiment, all signature validations for the document object are performed simultaneously by document validator 112.

Document storage 114 may include a data storage device operative to store documents for a period of time. In one embodiment, document storage 114 may include hard disk storage containing storage software such as a relation database management system (“RDMS”). In an alternative embodiment, document storage 114 may include a volatile storage device such as random access memory (“RAM”). Although illustrated as a single device, document storage 114 may be distributed across a plurality of storage devices or across a plurality of content providers similar to content provider 106. In yet another embodiment, document storage 114 may further include specialized or proprietary software operative to optimize the storage and retrieval of pages of interactive documents.

Rendering engine 116 may include a device operative to retrieve documents from document storage 114 and convert the stored documents to a format suitable for displaying or presenting to a user. In the illustrated embodiment, rendering engine 116 may be operative to retrieve document object models from document storage 114 and process the object data (e.g., textual, formatting and processing data) to generate a series of commands directing a user display device to display the document object. In one embodiment, rendering engine 116 may further be operative to receive interactive commands from a user via a content server 118. In response to an interactive command, rendering engine 116 may be operative to update the object model and display various portions of the object model as determined by the user.

Content server 118 may include a computing device operative to receive requests for interactive document content from a plurality of clients 102. Additionally, content server 118 is operative to transmit interactive document data to a plurality of client devices 102. In one embodiment, content server 118 is operative to receive instructions from a user utilizing a client device 102. For example, an interactive document may include a plurality of controls (e.g., “next page”, “previous page”, etc.) which, upon selection, are operative to transmit a message to the content server 118 indicating an action to be performed. Content server 118 may then be operative to transmit the received messages to the rendering engine 116.

Although illustrated as a client/sever architecture, alternative embodiments of the system 100 may exist wherein a plurality of elements within the content provider 106 are located within a client device 102. For example, a corporate terminal such as a bank terminal may contain a content server and rendering engine in addition to client-side components such as a display device. In this example, a client device may have limited communication with a remote storage device operative to store a plurality of previously authored documents.

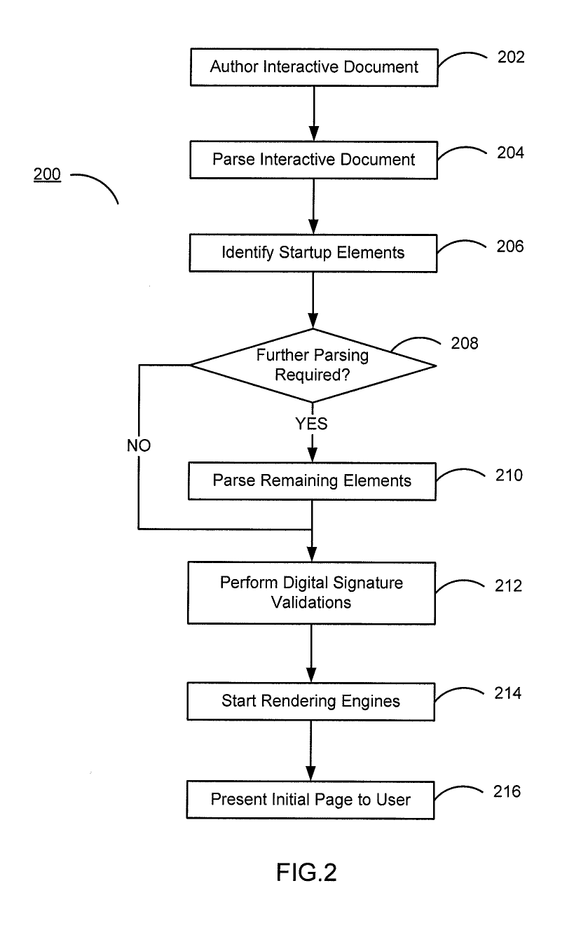

FIG. 2 presents a flow diagram illustrating a method for authoring and presenting an interactive document to a user according to one embodiment of the present invention, such as using the system 100 of FIG. 1. The leading steps of FIG. 2 may represent a pre-run time scenario, such as authoring the interactive document, step 202. In one embodiment, authoring an interactive document may include utilizing authoring software to create an interactive document. For example, authoring an interactive document may include using a WYSIWYG editor to graphically describe an interactive document. In one embodiment, an authored document may comprise a document written in a document markup language such as SGML, XML, HTML or any other structured or semi-structured markup language.

The method 200 then parses the interactive document, step 204. In one embodiment, parsing an interactive document includes reading an interactive document into memory and converting the interactive document to a processing object, such as an XML DOM object or similar construct able to store and update the content, structure or style of documents. Parsing a document object entails creating a dynamic document object having properties allowing the document to be subsequently manipulated via software products or programming languages. In one embodiment, the portion of the document content subject to attachment and detachment could be denoted by an XML markup, such as an XFDL (extensible Forms Description Language) page element. Parsing documents to form document objects is commonly understood in the art and will not be discussed further for the sake of brevity.

The method 200 then identifies a plurality of startup elements, step 206. In one embodiment, a start up element may include elements identified by an interactive document author as being necessary for the initial display of an interactive document. For example, startup elements may include the first page of an interactive form as well as dynamic code common to all pages of the interactive document. In one embodiment, the method 200 may select a node within an XML document corresponding to a predetermined “global” node to identify elements necessary for startup. For example, an interactive document may contain a page described by the following XML markup:

1. <page sid=“pageN”>
2. <!-- document content -->
3. </page>

### EXAMPLE 1

As illustrated in Example 1, a page having an “sid” of “pageN” (line 1) contains document content (line 2). As depicted, the “sid” of a page may comprise a “scope identifier” which corresponds to the name of a page with respect to the remainder of the document. An interactive document may contain a plurality of pages, each having a scope identifier illustrated in Example 1. Additionally, an interactive document may contain a global element specifying which pages are to be loaded on start up:

1. <globalpage sid=“global”>
2. <global sid=“global”>
3. ...
4. <pageloading>
5. <autoload>pageN pageM</autoload>

### EXAMPLE 2

As illustrated in Example 2, a global element (line 2) contains a pageloading element (line 4). In one embodiment, a pageloading element may comprise an element describing the actions of an interactive document on startup. In the illustrated example, the pageloading element contains an autoload element (line 5) containing names (‘sid’s) of a plurality of page elements. The autoload element may be operative to indicate which pages are to be ‘pre-attached’, i.e. parsed and otherwise fully prepared for rendering when the interactive document is first loaded. In the illustrated example, the autoload element specifies that pages identified with scope identifiers “pageN” and “pageM” be loaded when an interactive document is first rendered.

The method 200 checks to determine if further processing is required, step 208. This check may be made at the discretion of the interactive document author, or according to pre-determined constraints, such as system configuration settings. If further processing is required, the method 200 parses the remaining elements, step 210. If not, the method 200 performs core digital signature validations, step 212. In one embodiment, signature validations directed towards ancillary aspects of the document object (e.g., those not parsed) may be deferred for a later time, such as when the subsection of the document object is displayed on a user device.

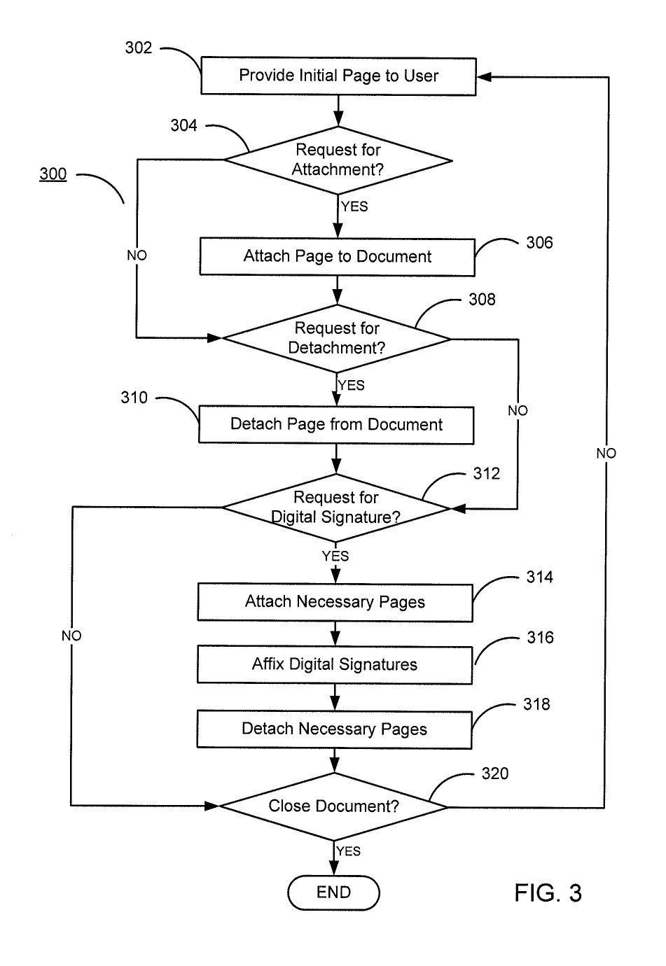

The method 200 then starts the rendering engines, step 214, and presents the initial page to the user, step 216. The initial page may also be expressed in terms of views, where the view is the plurality of pages presented to the user. The display may include displaying an initial view to the user with an initial set of pages, wherein additional views include additional pages that are attached or detached in accordance with the techniques described herein. In one embodiment, steps 214 and 216 may be performed at a determined time after step 212; that is, steps 214 and 216 may be able to be performed at a later time, subsequent to the validation of core digital signatures. The method of performing core digital signatures is described more fully with respect to FIG. 3.

Once the steps of FIG. 2 have been performed, the interactive document run time phase has begin and the future content attachment and detachment operations are subject to user interaction events. The document content may be envisioned in a three-fold partition: attached content being directly consumed by the end user, the content attached for anticipated consumption by the end user, and detached content. FIG. 3 illustrates steps performed during a run-time operation or phase.

FIG. 3 presents a flow diagram illustrating a method for attaching and detaching interactive document content according to one embodiment of the present invention. As illustrated, the method 300 provides an initial page to a user, step 302. It is noted that as used herein, the initial page includes one or more pages, or another terms, a plurality of pages. In one embodiment, providing an initial page to a user may include providing a first page of interactive document content to a user, the first page determined during an authoring phase by a document author. Additionally, a first page may contain global logic that is utilized by the initial page and a plurality of subsequent pages. The method 300 may determine the contents of an initial page based upon data stored within the interactive document.

The method 300 then performs a series of checks (steps 304, 308, 312 and 320) and performs methods associated with the checks. The first check the method 300 performs is to determine whether a request for an attachment has been received, step 304. A request for attachment may include an instruction sent by a user in response to the selection of a graphical user interface (“GUI”) object (e.g., selecting a “next page” button). Alternatively, or in conjunction with the foregoing, attaching a page may be an intelligent process that preemptively attaches pages the method 300 believes the user may need, such as for example neighboring content.

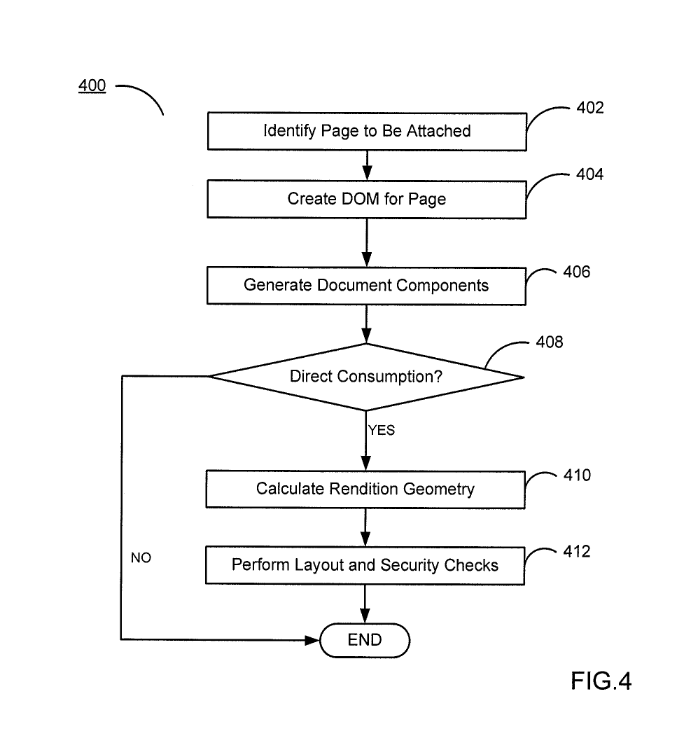

If a user requests the attachment of a page (or if the method 300 determines a page may be of future interest to the user), the method 300 attaches the page to the interactive document, step 306. In one embodiment, attaching a page to the current document may include parsing the page content, performing digital signature validations on the page and displaying the page to an end user. One embodiment of a method for attaching pages is described more fully with respect to FIG. 4.

In one embodiment, the definition of content attachment and detachment could be restricted to the most expensive data structures, including those responsible for data formatting, run-time computes and user interface representation. Alternatively, an embodiment may include the ability to attach and detach the entire underlying XML parse tree data structure (DOM) for portions of content.

The second check the method 300 performs is to determine whether a request for detachment has been received, step 308. A request for detachment may include an instruction sent by a user in response to the selection of a graphical user interface (“GUI”) object (e.g., selecting a “next page” button). Alternatively, or in conjunction with the foregoing, detaching a page may be an intelligent process that preemptively detaches pages the method 300 believes the user may no longer need.

In one embodiment, the decision process for content detachment ma be varied to accommodate differing requirements for speed versus memory optimization. Content detachment could be ignored altogether if processing speed is paramount, or a strategy to minimize attached content could be employed if computer memory is at a premium. One advantage of this approach is providing significant memory and processing speed optimizations for interactive document processing, such as electronic forms applications that employ a document-centric architecture. Despite the dramatically increasing size of forms applications, it is still possible to offer the disconnected fill experience, the ad hoc workflow capability, the digital signature security and the simplified integration to back-end system such as content management and workflow process servers.

If a user requests the detachment of a page (or if the method 300 determines a page may no longer be of interest to the user), the method 300 detaches the page from the interactive document, step 310. In one embodiment, detaching a page from the current document may include extracting data from the requested page, performing signature validations on the request page and removing the requested page from the display area of the interactive document. Extracting data from the requested page may be required to ensure that data entered into a page may be safely and compactly stored, while all unnecessary parts of the requested page are removed.

The third check the method 300 performs is to determine whether to digitally sign the interactive document, step 312. If a request for a digital signature is received, the method 300 first attaches all necessary pages, step 314. In one embodiment, attaching pages may include attaching all pages needed for user consumption or anticipated consumption during the signing process. The method 300 then affixes the digital signature, step 316. Methods of digitally signing documents are commonly understood in the art and will not be discussed further for the sake of brevity. After signing the interactive document, the method 300 detaches the necessary pages previously attached, step 318. In the illustrated embodiment, detaching the necessary pages may be performed by a method similar to that performed in step 310.

The last check the method 300 performs is to determine if the interactive document should be closed, step 320. In one embodiment, the method 300 may close a document in response to user interaction indicating the closure of a document. For example, a user may close an application displaying the document or may select a GUI object directed towards closing a document (e.g., a “close” button).

Although only four checks are described with respect to FIG. 3, a variety of other checks may be performed. For example, the method 300 may check for a “print” command. In this scenario, the method 300 may assemble all necessary pages and components of the document and may further perform digital signature validation steps on the assembled document pages, thus ensuring security and completeness of the printed document.

FIG. 4 presents a flow diagram illustrating a method for attaching a page to an interactive document according to one embodiment of the present invention. As illustrated, the method 400 identifies the page to be attached, step 402. In one embodiment, identifying a page to be attached may include identifying a page indicated by user interaction with an interactive document or, alternatively, may include preemptively identifying a page for user consumption which will be discussed further.

The method 400 then creates a document object model (“DOM”) for the identified page, step 404. In one embodiment, creating a document object model may include creating an object model from a given textual interactive document. For example, an interactive document page may comprise an XML formatted document containing a plurality of nodes, textual data and processing instructions from which an object model can dynamically be generated.

The method 400 generates the document object in steps 406, 408, 410 and 412. In step 406, the method 400 generates a plurality of document components. In one embodiment, document components may comprise repeated components, user interface components, user interface bindings, formatting constructs or presentation layer constructs.

The method 400 then determines if the identified page is to be utilized for direct consumption, step 408. In the illustrated embodiment, pages for direct consumption may include those pages that are explicitly requested by the user. For example, a page identified in response to a selection of a “next page” button may be considered a page for direct consumption.

Conversely, a page not considered for direct consumption may be a page that the method 400 determines may be of use to the user. That is, pages not for direct consumption may be selected automatically by the method 400 in response to a user performing a predefined action. As will be described further, pages not for direct consumption may bypass steps 410 and 412 as they are potentially unnecessary and should not utilize the additional computational resources required to visually display a page.

If a page is determined to be for direct consumption, the method 400 first calculates the rendition geometry, step 410. In one embodiment, rendition geometry may include information directed towards how the identified page should be rendered on a receiving client device. For example, a plurality of rendition geometries may exist based on hardware characteristics (e.g., desktop, laptop, mobile, etc.) or software characteristics (e.g., browser-based, standalone thin client, etc.).

The method 400 then performs layout and security checks for the identified page, step 412. In the illustrated embodiment, layout and security checks may include ensuring that the data contained within the identified page passes a predefined security policy as well as does not violate a predefined layout schema or set of layout guidelines.

Accordingly, the described invention provides for selective and dynamic elaboration of interactive documents, such as electronic form documents operable in a non-direct communication environment. Through the parsing, attachment and detachment, as well as including the security validation, workflows may be more effectively managed in a dynamic fashion, without undue hardships on processing speeds or computational overhead of existing systems. As an example, a typical form document may include sixty plus pages of content representing guided interview or wizard pages, the more traditional looking form pages, similar to original paper, additional calculation schedules, and helper screens. Under the herein described technique, load times can be reduced by a mere fraction of the load times for prior art techniques. Furthermore, on a server-based render engine, where forms for connected user may be maintained in memory, it is possible to use a lax content detachment strategy in order to maximize processing throughput at the expense of memory. Even in some embodiments, a significant optimization of memory is achieved because across many forms, users are at different points in the fill experience. It can be estimated that roughly half the users are less then half finished, therefore the average memory usage may be about 50 percent reduced.

The presently described invention provides numerous advantages over existing prior art techniques for providing secure interactive document content. For example, in regulated industries such as government industries or energy industries, secure documents are imperative, yet many aspects of the industry require mobile usage of interactive documents. In the energy sector oil pipeline inspectors perform highly regulated tasks that require constant validation and security, yet a pipeline inspector may be required to be on-site a majority of the time. The present invention allows for these interactive documents to be provided in an efficient manner, as it improvise upon the document-centric architecture, allowing an entire document to be accessed by a mobile professional as compared with previous techniques requiring a connection to a document source providing the document content. The presently described invention additionally exploits aspects of interactive documents to allow massive amounts of content to be available in a lightweight and user-friendly manner while maintaining the integrity of documents even when not connected to a third party source.

FIGS. 1 through 4 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

1. A computer-implemented method for providing interactive document content to a user, the method comprising:
authoring an interactive document, said interactive document comprising at least one interactive page;
storing the interactive document and parsing a plurality of pages defined within the interactive document;
providing an initial plurality of interactive pages to the user;
attaching a plurality of pages in response to a request for attachment of pages; and
displaying various pluralities of pages to a user during interaction with the document.

2. The method of claim 1 further comprising digitally signing a plurality of pages.

3. The method of claim 2 wherein digitally signing a plurality of pages includes deferring signature validations associated with ancillary aspects of the interactive document.

4. The method of claim 1 wherein said interactive document comprises an XML document containing data, user interface declarations and behavioral instructions.

5. The method of claim 1 wherein a subset of the original document comprises the pages designated as required attachments at an initialization time within the interactive document.

6. The method of claim 1, further comprising detaching a plurality of pages in response to a request for detachment of pages.

7. The method of claim 6 wherein attaching and detaching a plurality of pages comprises automatically determining pages to attach and detach.

8. The method of claim 6 wherein attaching and detaching a plurality of pages comprises attaching and detaching pages in response to processing instruction requests within the interactive document.

9. The method of claim 8 wherein a processing instruction request is a print request.

10. The method of claim 8 wherein the processing instruction request is a page next request.

11. A system for providing interactive document content to a user, the system comprising:
an authoring device operative to enable authoring an interactive document, said interactive document comprising at least one interactive page;
a document storage device storing the interactive document therein;
a parser operative to parse a plurality of pages defined within the interactive document;
a content server operative to provide an initial plurality of interactive pages to the user, the content server further operative to receive requests from a plurality of client devices for attachment of pages; and
the client devices operative to display various pluralities of pages to the user during interaction with the document.

12. The system of claim 10 wherein the content server is further operative to digitally sign a plurality of pages.

13. The system of claim 11 wherein digitally signing a plurality of pages includes deferring signature validations associated with ancillary aspects of the interactive document.

14. The system of claim 10 wherein said interactive document comprises an XML document containing data, user interface declarations and behavioral instructions.

15. The system of claim 10 wherein a subset of the original document comprises pages designated as required attachments at an initialization time within the interactive document

16. The system of claim 1, wherein the content server is further operative to detach a plurality of pages in response to a request for detachment of pages

17. The system of claim 16 wherein attaching and detaching a plurality of pages comprises automatically determining pages to attach and detach.

18. The system of claim 16 wherein attaching and detaching a plurality of pages comprises attaching and detaching pages in response to processing instruction requests within the interactive document.

19. The system of claim 18 wherein a processing instruction request is a print request.

20. The method of claim 18 wherein the processing instruction request is a page next request.
